(19) United States
(12) Patent Application Publication
(10) Pub. No.: US 2026/0226241 A1
(43) Pub. Date: Aug. 6, 2026

(54) COPPER-POLYMER RESIN COMPOSITE AND METHOD OF MANUFACTURING THE SAME

(71) Applicant: DYP CO., LTD., Ansan-si (KR)

(72) Inventors: Zuojia WANG, Ansan-si (KR); Hyeokchul YANG, Ansan-si (KR); Seongyean HWANG, Ansan-si (KR); Juhyun SUN, Ansan-si (KR); Mijeong MUN, Ansan-si (KR); Sang Chul SON, Ansan-si (KR)

(21) Appl. No.: 19/042,572

(22) Filed: Jan. 31, 2025

(51) Int. Cl. C08J 5/18; C08J 5/12

(52) U.S. Cl. CPC C08J 5/18; C08J 5/12; C08J 2381/04

(57) ABSTRACT

Provided is a method of manufacturing the present disclosure a composite composed of copper and a polymer resin. According to an embodiment of the present disclosure, the method includes an electroless oxidation step of performing the electroless oxidization for the copper in a solution for electroless oxidation to form a porous oxide film having a roughened structure on the surface of the copper; and a step of bonding the copper with the polymer resin.

### BACKGROUND OF THE DISCLOSURE

### Field of the Disclosure

The present disclosure relates to a metal-polymer resin composite and a method of manufacturing the same, and more particularly to a copper-polymer resin composite in which copper and a polymer resin are bonded to each other, and a method of manufacturing the copper-polymer resin composite.

### Description of the Related Art

Copper, which is a metal with excellent electrical conductivity, is widely used as a material for electrical components of various electrical and electronic products. When copper is applied to an electrode terminal for electrical connection, it can be used as a copper-polymer resin composite structure where copper and polymer resin are bonded to each other. For example, when copper is used as an electrode terminal of a cap plate assembly used in a secondary battery lithium battery cell, a polymer resin, which is an insulator, can be formed between the cap plate and the copper electrode terminal positioned to pass through it by insert injection. In this case, a part of the copper electrode terminal is bonded with the polymer resin to form a copper-polymer resin composite structure. In a copper-polymer resin composite, it is most important to secure a strong bonding force between copper and a polymer resin. However, the copper-polymer resin composite has a problem in that the bonded materials are a metal and a polymer which are different materials, so it is difficult to implement a strong bonding force between the two materials due to the heterogeneity of the materials.

### SUMMARY OF THE DISCLOSURE

Therefore, the present disclosure has been made in view of the above problems, and it is an object of the present disclosure to provide a copper-polymer resin composite with excellent bonding strength at the interface between the copper and polymer resin thereof and a method of manufacturing the copper-polymer resin composite. It will be understood that the technical problems are only provided as examples, and the scope of the present disclosure is not limited thereto.

In accordance with an aspect of the present disclosure, the above and other objects can be accomplished by the provision of a method of manufacturing a copper-polymer resin composite.

According to an embodiment of the present disclosure, the method may include a degreasing step of degreasing a surface of the copper; an electroless oxidation step of performing the electroless oxidization for the copper in a solution for electroless oxidation to form a porous oxide film having a roughened structure on the surface of the copper; and a step of bonding the copper with the polymer resin.

According to an embodiment of the present disclosure, the solution for electroless oxidation may be a mixed solution prepared by dissolving two or more substances selected from sodium sulfate, sodium hydroxide, sodium chlorate, sodium chlorite and sodium phosphate in water.

According to an embodiment of the present disclosure, the oxide film may have a thickness of 50 to 800 nm.

According to an embodiment of the present disclosure, a sum of concentrations of the two or more substances contained in the solution for electroless oxidation may be 1 to 50 wt %.

According to an embodiment of the present disclosure, a concentration of each of the two or more substances contained in the solution for electroless oxidation may be in a range of 1 wt % or more and less than 30 wt %.

According to an embodiment of the present disclosure, a temperature of the solution for electroless oxidation in the electroless oxidation step may be in a range of 20 to 80° C.

According to an embodiment of the present disclosure, the polymer resin may include one of polyphenylene sulfide, polybutylene terephthalate, liquid crystal polymers, polyether ether ketone, polyphthalamide, polyamide, polycarbonate and polypropylene.

According to an embodiment of the present disclosure, in the degreasing step, a degreasing solution may include ionic water or sulfuric acid.

In accordance with another aspect of the present disclosure, provided is a copper-polymer resin composite.

According to an embodiment of the present disclosure, the copper-polymer resin composite may include copper; and a polymer resin bonded to at least a region of the copper.

According to an embodiment of the present disclosure, a porous oxide film having a roughened structure may be formed on the surface of the copper bonded to the polymer resin.

According to an embodiment of the present disclosure, the oxide film may have a thickness of 50 to 800 nm.

According to an embodiment of the present disclosure, a bonding strength between the copper and the polymer resin may be 40 MPa or more.

According to an embodiment of the present disclosure, the polymer resin may include one of polyphenylene sulfide, polybutylene terephthalate, liquid crystal polymers, polyether ether ketone, polyphthalamide, polyamide, polycarbonate and polypropylene.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 illustrates a method of manufacturing a copper-polymer resin according to an embodiment of the present disclosure step by step;

FIG. 2 illustrates the cross-section of the surface of copper of Example 1 observed using an electron microscope; and

FIG. 3 illustrates the cross-section of the surface of copper of Comparative Example 1 observed using an electron microscope.

### DETAILED DESCRIPTION OF THE DISCLOSURE

Hereinafter, one or more preferred embodiments of the present disclosure will be described in detail with reference to the accompanying drawings. Embodiments of the present disclosure are provided to more completely explain the present disclosure to those skilled in the art, and the following embodiments may be modified in many different forms, but the scope of the present disclosure is not limited to the following embodiments. Rather, the embodiments are provided to make the disclosure thorough and complete and to fully convey the technical idea of the disclosure to those skilled in the art.

In this specification and the accompanying claims, copper refers to both pure copper and copper alloys.

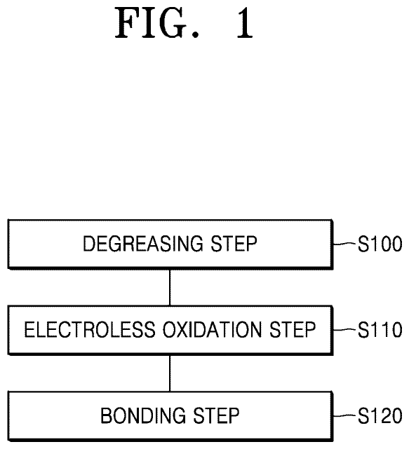

FIG. 1 illustrates a method of manufacturing a copper-polymer resin according to an embodiment of the present disclosure step by step. The method of manufacturing a copper-polymer resin composite includes a copper surface treatment step composed of a degreasing step (S100) and an electroless oxidation step (S110); and a bonding step (S120) of bonding the copper, whose surface treatment has been completed, with a polymer resin.

Referring to FIG. 1, the degreasing step (S100) of degreasing the surface of copper to be bonded to a polymer resin is performed. The degreasing step is a step of removing various impurities including oil present on the surface of copper using a degreasing solution. The copper may be degreased by being immersed in a container containing a degreasing solution for a predetermined time. Alternatively, the surface of copper may be degreased by spraying the degreasing solution onto the copper using a nozzle, etc.

To increase the efficiency of degreasing, ultrasonic treatment for degreasing may be performed while supplying ultrasonic waves using an ultrasonic cleaning device. For example, copper may be immersed in a degreasing solution, and degreasing can be performed by applying ultrasonic waves to the copper immersed in the degreasing solution using an ultrasonic cleaning device.

The degreasing solution used in the degreasing step (S100) may include ionic water. Ionic water is water that has been electrolytically treated with distilled water, and may include acidic ionic water or alkaline ionic water. As another example of the degreasing solution, sulfuric acid (H₂SO₄) may be included.

After the degreasing step is completed, the electroless oxidation step (S110) is performed. The electroless oxidation step (S110) is a step of immersing copper in a solution for electroless oxidation, and then forming a copper oxide film on the copper surface by a chemical reaction.

The solution for electroless oxidation may be a mixed solution in which two or more substances selected from sodium sulfate (Na₂SO₄), sodium hydroxide (NaOH), sodium chlorate (NaClO₃), sodium chlorite (NaClO₂) and sodium phosphate (Na₃PO₄) are dissolved in water.

The total content of the substances in the solution for electroless oxidation may be 1 to 50 wt %, preferably 5 to 30 wt %. In addition, the concentration of each of the two or more substances contained in the solution for electroless oxidation may be 1 wt % or more and less than 30 wt %.

The temperature of the solution for electroless oxidation during electroless oxidation may be 20 to 80° C., and the electroless oxidation may be performed for 30 to 600 sec.

In the electroless oxidation step (S110), a porous oxide film having a roughened structure is formed on the copper surface. As the porous oxide film having a roughened structure is formed on the copper surface, the roughness of the copper surface increases, and thus the area of the copper surface bonded with the polymer resin increases. In addition the roughened structure performs the role of mechanically interlocking the copper and the polymer resin when they are bonded, and in the bonded state, the roughened structure may disperse the force transmission to make the bonding more solid, and increase the frictional force and fixing force to prevent slipping between the copper and the polymer resin. In addition, the bonding force may be improved by increasing the bonding area between the copper and the polymer resin due to the increase in the area of the copper surface.

The oxide film formed on the copper surface may serve as a bonding layer to increase the bonding force between the copper and the polymer resin. Accordingly, the oxide film may be referred to as a bonding layer. The thickness of the oxide film may be in the range of 50 to 800 nm, preferably in the range of 100 to 500 nm, more preferably in the range of 200 to 400 nm.

After the electroless oxidation step (S110) for copper is completed, a bonding step for bonding the copper and the polymer resin is performed (S120). The bonding step (S120) may include, for example, an insert injection step. In the case of insert injection, the copper for which the electroless oxidation step (S110) has been completed is loaded into a mold of an insert injection machine and then fixed. Next, when a molten polymer resin is injected into the mold, the high-temperature molten polymer resin is solidified while surrounding the copper. When the solidification is completed, a copper-polymer resin composite in which at least a portion of the copper surface is bonded to the polymer resin is formed. When the insert injection process is completed, the mold is removed to obtain a copper-polymer resin composite. The bonding by such insert injection is one example, and the bonding method of the present disclosure is not limited thereto.

The polymer resin may include one of polyphenylene sulfide, polybutylene terephthalate, liquid crystal polymers, polyether ether ketone, polyphthalamide, polyamide, polycarbonate and polypropylene.

When the electroless oxidation step for copper according to an embodiment of the present disclosure is performed as described above, a porous oxide film of a roughened structure is formed on the surface of the copper. This porous oxide film acts as a bonding layer, and accordingly, the presence of this bonding layer may cause excellent bonding force properties between the copper and the polymer resin. For example, the bonding strength of the copper-polymer resin composite may be 40 MPa or more.

The technology for forming such a copper-polymer resin composite may be applied, for example, to the manufacture of a cap plate assembly used in lithium battery cells for secondary batteries. The cap plate assembly is a component installed in a housing opening of the battery cell and used to cover and seal the opening of the housing. The cap plate assembly includes a cap plate using a metal material, for example, aluminum, and an electrode terminal using copper. The electrode terminal may be placed in a hole penetrating a cap plate, and in this case, a polymer resin as an insulator may be formed between the cap plate and an electrode terminal by insert injection. Accordingly, at least a part of the electrode terminal surface is bonded to the polymer resin to form a composite. The interface between the electrode terminal and the polymer resin in the cap plate should have high bonding strength and excellent sealing characteristics to effectively seal the leakage of a battery electrolyte contained in the cell. When performing the surface treatment according to one embodiment of the present disclosure on the copper electrode terminal, excellent bonding characteristics may be exhibited at the interface between the copper and the polymer resin, so that the electrode terminal may be stably fixed within the cap plate while obtaining sufficient sealing characteristics and electrical insulation characteristics.

### Experimental Examples

Hereinafter, a desirable experimental example is presented to help understand the present disclosure. However, the experimental example below is only to help understand the present disclosure, and the present disclosure is not limited to the experimental example below.

A plurality of copper plates was prepared. The prepared copper plates were immersed in a sulfuric acid solution to perform degreasing treatment. An electroless oxidation step was performed on the copper plates that had undergone the degreasing step. The copper plates that had undergone the electroless oxidation step were used to manufacture a copper-polymer resin composite using an insert injection machine. Polyphenylene sulfide was used as a polymer resin.

Table 1 shows the types and concentrations of substances contained in the solutions for electroless oxidation corresponding to the examples and the comparative examples. The compositions of the components constituting the solutions for electroless oxidation are expressed as wt % of the entire solution.

TABLE 1

| Specimen | Solution for electroless oxidation |
|---|---|
| Example 1 | Sodium hydroxide 5 wt % |
| | Sodium chlorite 10 wt % |
| | Sodium phosphate 10 wt % |
| Example 2 | Sodium hydroxide 5 wt % |
| | Sodium chlorite 10 wt % |
| | Sodium phosphate 15 wt % |
| Example 3 | Sodium hydroxide 5 wt % |
| | Sodium chlorite 15 wt % |
| | Sodium phosphate 10 wt % |
| Comparative Example 1 | Sodium hydroxide 30 wt % |
| | Sodium chlorite 10 wt % |
| | Sodium phosphate 20 wt % |
| Comparative Example 2 | Sodium hydroxide 10 wt % |
| | Sodium chlorite 20 wt % |
| | Sodium phosphate 30 wt % |
| Comparative Example 3 | Sodium hydroxide 10 wt % |
| | Sodium chlorite 30 wt % |
| | Sodium phosphate 20 wt % |
| Comparative Example 4 | Sodium hydroxide 25 wt % |
| Comparative Example 5 | Sodium chlorite 25 wt % |
| Comparative Example 6 | Sodium phosphate 25 wt % |

Referring to Table 1, all of the electroless solutions of Examples 1 to 3 were mixed solutions in which sodium hydroxide, sodium chlorite, and sodium phosphate were dissolved in distilled water. In Examples 1 to 3, each of sodium hydroxide, sodium chlorite, and sodium phosphate had a composition range of 1 wt % or more and less than 30 wt %, and the total composition of sodium hydroxide, sodium chlorite, and sodium phosphate was 20 wt % of the total mixed solution, which is less than 50 wt %.

Examining the electroless solutions corresponding to the comparative examples, all of Comparative Examples 1 to 3 were mixed solutions in which sodium hydroxide, sodium chlorite, and sodium phosphate were dissolved in distilled water. However, in the case of the composition containing all of sodium hydroxide, sodium chlorite, and sodium phosphate, all of Comparative Examples 1 to 3 showed 60 wt % which exceeds 50 wt %.

Meanwhile, the solutions for electroless oxidation of Comparative Examples 4 to 6 were solutions in which only one substance was mixed with distilled water. Comparative Example 4 was a solution in which only sodium hydroxide was mixed with distilled water, Comparative Example 2 was a solution in which only sodium chlorite was mixed with distilled water, and Comparative Example 3 was a solution in which only sodium phosphate was mixed with distilled water. In all of Comparative Examples 4 to 6, the concentration of substances in the solution was 25 wt %.

The prepared copper plates were immersed in the prepared solutions for electroless oxidation as shown in Table 1 and maintained for 90 seconds to perform electroless oxidation. The temperature of the solutions for electroless oxidation was maintained at 60° C.

Table 2 shows the characteristics of the copper-polymer resin composites corresponding to the examples and the comparative examples. Referring to Table 2, the thickness of bonding layer refers to the thickness of the oxide film formed on the copper surface in the electroless oxidation step. The thickness of the bonding layer was measured by observing the cross-section of the copper surface with an electron microscope after the electroless oxidation step was completed.

For sealability evaluation, the helium leak pressure was measured to confirm the sealability between the copper and the polymer resin. When the helium leak pressure was less than 0.003 bar, it was marked as O, and when the helium leak pressure was 0.003 bar or more, it was marked as X.

The bonding strength refers to the bonding strength between copper and polymer resin, which was measured as the tensile fracture strength between copper and polymer resin using a tensile tester.

TABLE 2

| | Thickness of | Sealability | Bonding |
|---|---|---|---|
| Specimen | bonding layer (nm) | evaluation | strength (MPa) |
| Example 1 | 220 | ◯ | 46 |
| Example 2 | 310 | ◯ | 49 |
| Example 3 | 290 | ◯ | 50 |
| Comparative | 20 | X | 15 |
| Example 1 | | | |
| Comparative | 30 | X | 17 |
| Example 2 | | | |
| Comparative | 20 | X | 13 |
| Example 3 | | | |
| Comparative | 25 | X | 12 |
| Example 4 | | | |
| Comparative | 30 | X | 9 |
| Example 5 | | | |
| Comparative | 25 | X | 11 |
| Example 6 | | | |

Referring to Table 2, the thicknesses of the bonding layers of Examples 1 to 3 were 220 nm, 310 nm, and 290 nm, respectively. All of the examples showed excellent sealing characteristics in the sealability evaluation and excellent bonding strength values greater than 40 MPa.

In comparison, Comparative Examples 1, 2, and 3 had bonding layer thicknesses of 20 nm, 30 nm, and 20 nm, all of which were thinner than 50 nm. All of Comparative Examples 1 to 3 did not show any sealing effect in the sealability evaluation, and showed low bonding strength values less than 40 MPa.

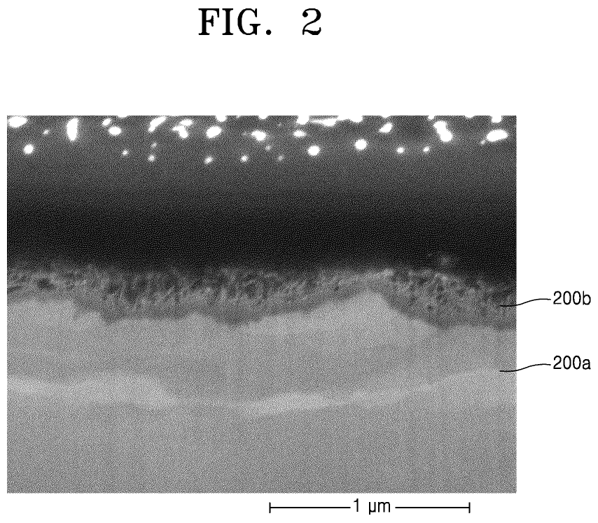

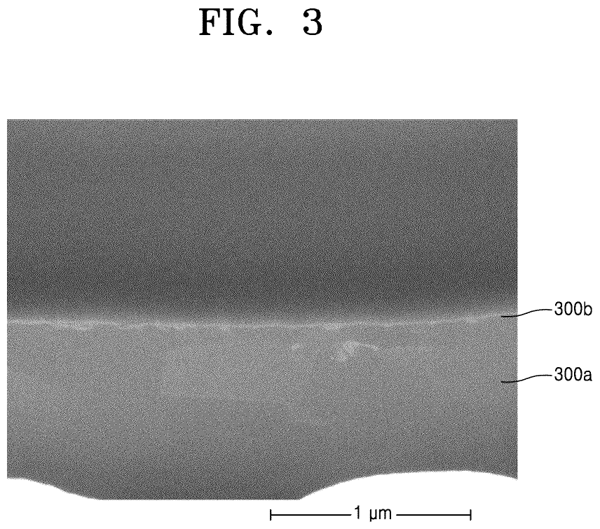

FIG. 2 illustrates the cross-section of the surface of copper of Example 1 observed with an electron microscope In FIG. 2, reference numerals (200a) and (200b) indicate copper and the oxide film formed on the surface of the copper, respectively. FIG. 3 illustrates the cross-section of the surface of copper of Comparative Example 1 observed with an electron microscope. In FIG. 3, reference numerals (300a) and (300b) indicate copper and the oxide film formed on the surface of the copper, respectively.

Referring to FIG. 2, it can be seen that a porous oxide film with a fine roughened structure was formed on the copper surface of Example 1, creating a very rough surface. In comparison, referring to FIG. 3, it can be confirmed that a very thin oxide film of 20 nm without roughness is formed on the copper surface of Comparative Example 1. Accordingly, in Comparative Example 1, it is difficult to expect the effect of improved adhesion due to the roughened structure as in Example 1. It can be confirmed that the difference in bonding force between the coppers and the polymer resins is caused by the difference in the microstructures of the oxide layers of Example 1 and Comparative Example 1.

In accordance with the technical idea of the present disclosure, a copper-polymer resin composite having excellent bonding strength between the copper and polymer resin thereof can be manufactured. The effects of the present disclosure described above are described as examples, and the scope of the present disclosure is not limited by these effects.

It will be obvious to those skilled in the art, to which the technical idea of the disclosure pertains, that the technical idea of the disclosure described above is not limited to the above-described embodiments and the accompanying drawings and various substitutions, modifications, and changes are possible within the scope of the technical idea of the disclosure.

What is claimed is:

1. A method of manufacturing a copper-polymer resin composite, the method comprising:
a degreasing step of degreasing a surface of copper;
an electroless oxidation step of performing electroless oxidization for the copper in a solution for electroless oxidation to form a porous oxide film having a roughened structure on the surface of the copper; and
a step of bonding the copper with a polymer resin,
wherein the solution for electroless oxidation is a mixed solution prepared by dissolving two or more substances selected from sodium sulfate, sodium hydroxide, sodium chlorate, sodium chlorite and sodium phosphate in water.

2. The method according to claim 1, wherein the oxide film has a thickness of 50 to 800 nm.

3. The method according to claim 1, wherein a sum of concentrations of the two or more substances contained in the solution for electroless oxidation is 1 to 50 wt %.

4. The method according to claim 1, wherein a concentration of each of the two or more substances contained in the solution for electroless oxidation is in a range of 1 wt % or more and less than 30 wt %.

5. The method according to claim 1, wherein a temperature of the solution for electroless oxidation in the electroless oxidation step is in a range of 20 to 80° C.

6. The method according to claim 1, wherein the polymer resin comprises one of polyphenylene sulfide, polybutylene terephthalate, liquid crystal polymers, polyether ether ketone, polyphthalamide, polyamide, polycarbonate and polypropylene.

7. The method according to claim 1, wherein, in the degreasing step, a degreasing solution comprises ionic water or sulfuric acid.

8. A copper-polymer resin composite, comprising: copper; and a polymer resin bonded to at least a region of the copper,
wherein a porous oxide film having a roughened structure is formed on a surface of the copper bonded to the polymer resin, and
the oxide film has a thickness of 50 to 800 nm.

9. The copper-polymer resin composite according to claim 8, wherein a bonding strength between the copper and the polymer resin is 40 MPa or more.

10. The copper-polymer resin composite according to claim 8, wherein the polymer resin comprises one of polyphenylene sulfide, polybutylene terephthalate, liquid crystal polymers, polyether ether ketone, polyphthalamide, polyamide, polycarbonate and polypropylene.
